(19) United States
(12) Patent Application Publication
(10) Pub. No.: US 2003/0119531 A1
(43) Pub. Date: Jun. 26, 2003

(54) Dynamic selection of avatar policies based on physical device location and derived user control

(76) Inventors: Charles M. Patton, Eugene, OR (US); Stephen A. Loughran, Corvallis, OR (US); Rajeev K. Pandey, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/028,807

(22) Filed: Dec. 21, 2001

(51) Int. Cl. H04Q 7/20

(52) U.S. Cl. 455/461; 455/445; 455/456

(57) ABSTRACT

The present invention provides methods, a computer-readable medium and a destination selection system that provide for automatically selecting, for a user, at least one destination avatar to which to send received information based on context information and user-defined policy-selection rules. In one embodiment, the method includes the steps of examining, by a destination selection system, user location information and determining the at least one destination avatar to which the received information is to be delivered based on the context information and the user-defined policy-selection rules.

### BACKGROUND OF THE INVENTION

The present invention relates to receiving data communications and more particularly, is related to a system and method for automatically forwarding received communications to a desired avatar.

Present devices, such as computers, for example, receive information from a variety of sources. A user typically must manually interact with their devices to establish what type of connection or contact a request for information should have. Emails are typically formatted in accordance with whatever format has been selected by the email service provider. Services are available to collect all received content and parse it out based on rules set by the receiver.

Virtual devices may contain information that the user wishes to receive via a physical device. Such virtual devices that are associated with particular physical devices to provide services to the physical devices are called device avatars, or simply, avatars. However, there is no present device or method for the avatar to automatically forward received communications to a desired destination in a desired format.

Hence, a method and device are needed to facilitate communication between avatars and physical devices.

### SUMMARY OF THE INVENTION

The present invention provides methods a computer-readable medium and a destination selection system for automatically selecting, for a user, at least one destination avatar to which to send received information based on context information and user-defined policy-selection rules. In one embodiment, the steps include examining, by a destination selection system, user location information and determining the at least one destination avatar to which the received information is to be delivered based on the context information and the user-defined policy-selection rules.

### BRIEF DESCRIPTION OF THE DRAWINGS

FIG. 1 is a flow chart showing one embodiment of steps for a method in accordance with the present invention.

FIG. 2 is a flow chart showing another embodiment of steps for a method in accordance with the present invention.

FIG. 3 is a block diagram of one embodiment of a computer-readable medium having computer-executable instructions for performing steps in accordance with the present invention.

FIG. 4 is a block diagram of one embodiment of a destination selection system in accordance with the present invention.

### DETAILED DESCRIPTION OF PREFERRED EMBODIMENTS

At an avatar, a user may receive content from different sources in a preferred format or have the information sent by the avatar to a particular destination where the format may be changed “on the fly” and redirected as the user changes his activities. By examining the user's behavior, his location, who and what is near his location and his recent activities such as, for example, what is planned in his diary and other information sources, an avatar may be selected which fits a given situation. From the context-driven choice of avatar, a device may alter its behavior and communications with the user. Once an embodiment of the present invention is trained or “tweeked”, it can provide the user with the content he desires in the format he prefers for the selected receiving device. Thus, an embodiment of the present invention maximizes the delivery mechanism for content from avatars.

A user may list multiple contact points or avatars for receiving input. Such avatars may represent the user's home and work roles, or they may represent roles within those broader contexts such as, for example, “traveling on holiday,” “visiting a different office,” “in my car,” and “very busy with work.” Each avatar may have its own contact policy and, where desired, may direct incoming messages, email and phone calls to different locations.

By examining the user's behavior, his location, who and what is located proximate to him and his recent activities as well as his planned activities as well as any other available information sources, in many cases the avatar that is appropriate for a particular situation may be selected. From this context-driven choice of avatar, devices may alter their behavior and communications with the user.

For example, the “visiting a different office” avatar may route telephone calls from some people to a cellular phone and redirect the telephone calls from other people to voicemail. Similarly, the avatar may route email from selected persons to the cellular phone or page of the user while storing the rest for later viewing. Where desired, the “in office” avatar may route the calls to the office and email to an inbox. Similarly, the “family contact” avatar, while the user is at the office, may store all incoming messages and email for later viewing. In one embodiment, when the user is home, the “family contact” avatar may take control of incoming telephone calls and email and deliver them to the user, while the “work contact” avatar may store incoming communications to be viewed later.

A benefit of the automated avatar selection is that users don't need to actively control their policies regarding communication and printing. Instead, the users may define the rules for when the policies are chosen, and the avatars may then determine when the rules are to be applied.

To determine which rules to apply, the avatars examine the context of the information being received. Devices provide what context information they have, such as network address assignments, cellular data from cellular phones, location data from Global Positioning System (GPS) receivers, power information from the user's notebook computer, active application data from the devices that the user is using, and the like, to the rule determining system. Web sites may be split into work and recreational sections also, for extra data.

The context determining system integrates information from all the devices belonging to an individual, to build a richer composite model of their state. For example, a notebook computer may not include information that denotes the user's location, but the user's cellular phone may have such information. The composite information may be used to approximate the user's current state by determining the most likely context, or the likeliest few probabilities of contexts. The approximation may be refined by inferring what facts are derived if the approximation is correct and sending information in accordance with the derived facts. For example, if the user is at home, the printer “Home DeskJet” is accessible a short distance from the user, and the device may test the derived facts and attempt to transmit information directly to the printer. When the context determination determines that there is a high probability that it knows the user's state, it may notify applications and devices that have registered an interest and enable the appropriate avatars.

Where desired, for privacy reasons, local device data may be processed by the local device itself, which then may upload a status of “at home,” “at work,” or “traveling” to the remote services, thus providing a savings on bandwidth usage.

While automated context-driven choice of avatar is generally quite useful, the system is arranged to allow the user to override the automated selection with the user's choices. Where desired, the user may utilize the manual override function to test rules as well as compensate for incorrect inferences.

Thus, incoming communications such as email, instant messenger messages, photographs and the like are sent to a destination avatar, but the actual destination is not specified in the avatar. Instead, the destination selection system selects the destination avatar based on the derived context of the user.

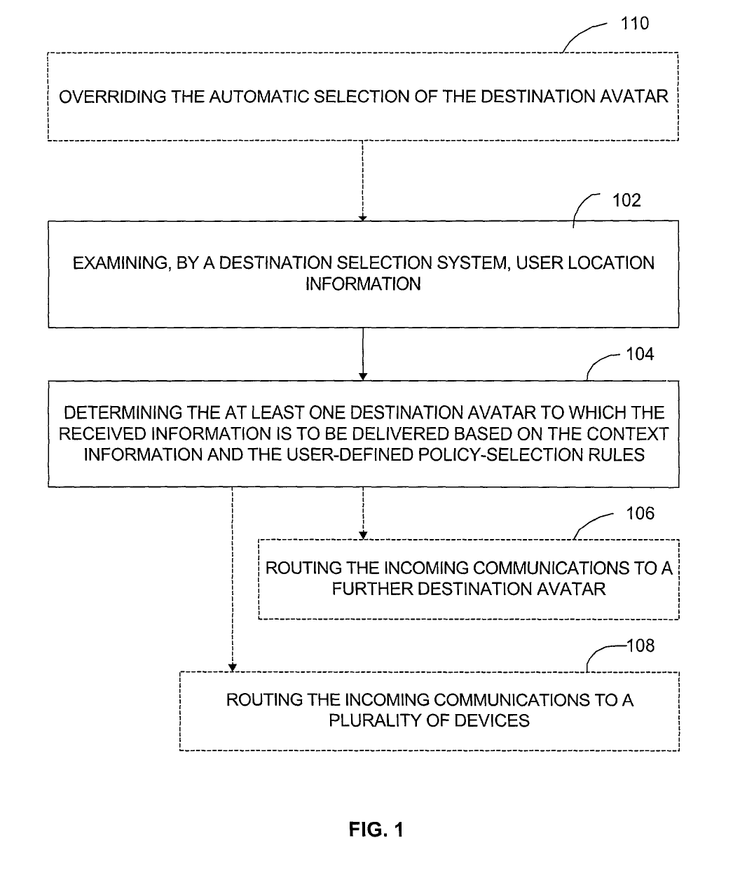

FIG. 1 is a flow chart showing one embodiment of steps for a method in accordance with the present invention. The method provides steps for automatically selecting, for a user, at least one destination avatar based on context information and user-defined policy-selection rules. First, a destination selection system examines (at block 102) user location information. Such user location information may be obtained, for example, in the manner discussed above. Then, the destination selection system determines (104) the at least one destination avatar to which the received information is to be delivered based on the context information and the user-defined policy-selection rules. The destination avatar decision is made by referring to the known location information and the rules previously set out by the user and selecting a best approximation for the desired destination avatar. If desired, the rules may provide for routing (106) incoming communications to a further destination avatar, for example, if an email remains unread for a predetermined period of time. Also, the rules may provide for routing (108) the incoming communications to a plurality of devices. For example, when a need for information from a particular source is very high and the user may be in and out of his car taking care of other business, the user may wish to specify that incoming information from the specified source be sent to his cell phone as well as his automobile phone.

Typical devices include a cellular phone, a personal computer located at a workplace, a laptop computer, a personal computer located at a residence, a camera and the like. User location information may include a user's behavior, a user's location, location of an individual proximate to the user, the user's recent activities, and the user's planned activities. The destination selection system may be, for example, a designated avatar. Generally, the designated avatar is associated with a particular device, and sends the received information to its associated device.

Generally, if desired, the user may override 110 the automatic selection of the destination avatar. For example, if the user's plans change, and he suddenly leaves on a short vacation, he may desire to have certain important received information come directly to his cell phone or laptop computer rather than be directed to destination avatars at his residence.

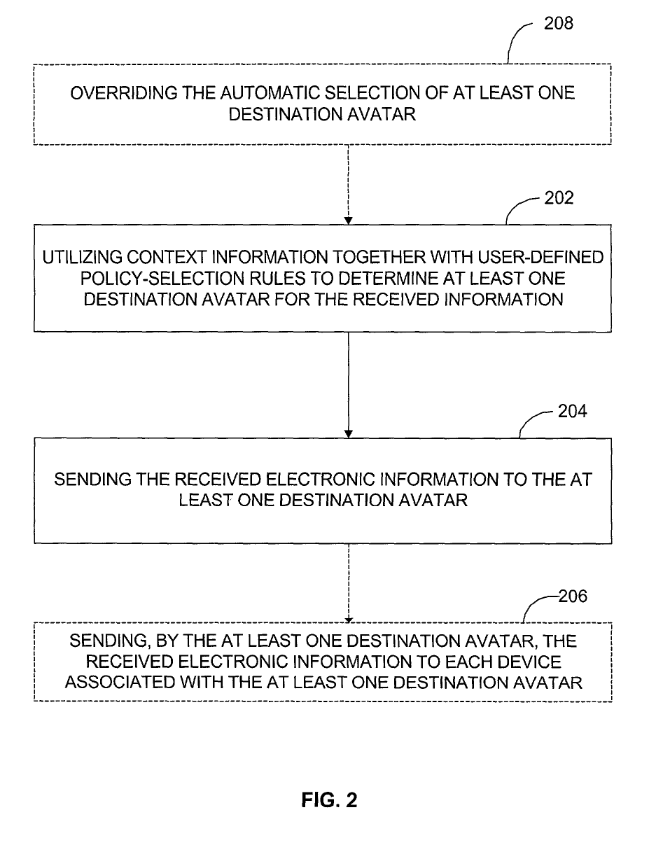

FIG. 2 is a flow chart showing another embodiment of steps for a method in accordance with the present invention. The method provides for dynamically routing received electronic information for a user. The steps include utilizing (202) context information together with user-defined policy-selection rules to determine at least one destination avatar for the received electronic information and sending (204) the received electronic information to the at least one destination avatar. Next, the at least one destination avatar sends (206) the received electronic information to each device associated with the at least one destination avatar. Examples of some devices that may receive information are listed above. Also, where desired, the user or another selected individual may override (208) the automatic selection of a destination avatar and control the destination of the received electronic information by sending different instructions.

The context information may, for example, include the user's network address assignment, cellular data from the user's cellular phone, location data for the user, power information from the user's notebook computer, active application data from devices that the user is using, Web site work information and/or Web site recreational information or combinations thereof. Where available, location data may include information from Global Positioning System receivers.

The user-defined policy-selection rules may include, for example, rules that indicate a selected destination avatar for at least one of: urgent messages, work messages, personal messages, personal photographs, messages from a selected group of people to the user when the user is visiting a different office, and/or messages from people failing to be in the first group of people wherein the messages are sent to the user when the user is visiting a different office. When messages are sent to the user when the user is in a different office, the user may, where desired, differentiate between how such messages are to be handled by his cellular phone, his email, and his pager.

Typically, where desired, the user may interrupt (208) the automatic selection of the at least one destination avatar and enter different rules and location data, thus changing the destinations of received information.

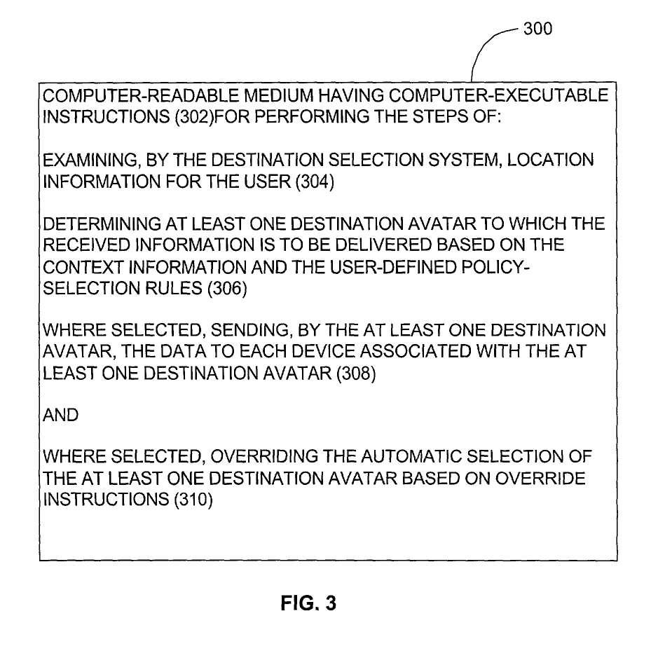

FIG. 3 is a block diagram of one embodiment of a computer-readable medium (300) having computer-executable instructions (302) for performing steps in accordance with the present invention. The computer-readable medium is utilized for implementing a destination selection system useful in directing received information in association with a plurality of devices for a user, wherein the plurality of devices are coupled to a computer network. The computer network provides a network connection for transmitting data to the destination selection system for delivery to at least one device of the user. The computer-executable instructions stored on the computer-readable medium are utilized for performing a method of automatically selecting, for the user, a destination avatar associated with at least one device of the plurality of devices based on context information and user-defined policy-selection rules in accordance with the invention. The steps include examining (304), by the destination selection system, location information for the user and determining (306) at least one destination avatar to which the received information is to be delivered based on the context information and the user-defined policy-selection rules. In one embodiment, the destination selection system may be a sorting avatar. Upon determining the at least one destination avatar, the computer-executable instructions may further include a step of sending (308), by the at least one destination avatar, the received information to each device associated with the at least one destination avatar. That is, each destination avatar generally sends its received information to its associated device. Examples of such devices, typical context information and user-defined policy-selection rules are recited above. Also, the computer-executable instructions may provide instructions for implementing overriding (310) instructions.

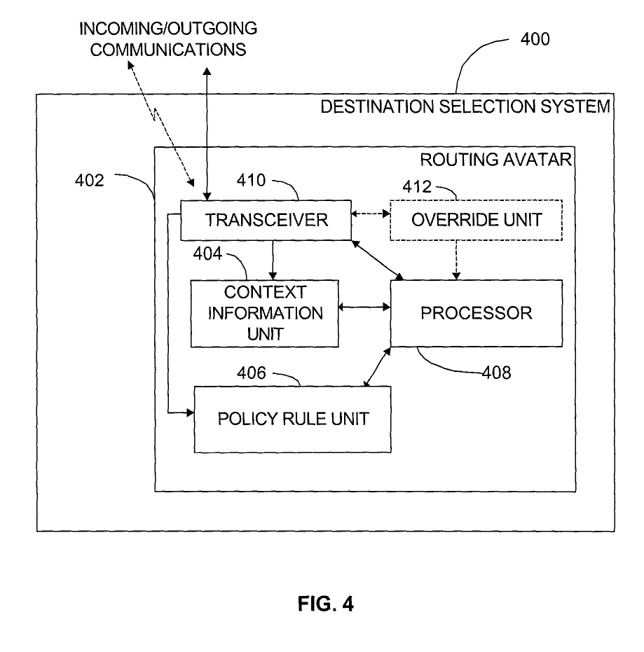

FIG. 4 is a block diagram of one embodiment of a destination selection system (400) in accordance with the present invention, wherein the destination selection system (400) automatically selects a destination avatar for incoming communications for a user. The destination selection system (400) includes a routing avatar (402) that includes a context information unit (404), a policy rule unit (406), a processor (408) and a transceiver (410). Incoming communications are received by the transceiver (410), which also transmits outgoing communications. The context information unit (404) is coupled to the transceiver (410) and to the processor (408) and receives and stores context information. The policy rule unit (406) is coupled to the transceiver (410) and to the processor (408), and is used for storing user policy rule input. The processor (408) is coupled to the context information unit (404), the policy rule unit (406) and the transceiver (410). The processor (408) uses the location context information and the user policy rule input to select a destination avatar (not shown). The transceiver (410) is coupled to receive incoming information, the context information unit (404), the policy rule unit (406) and the processor (408). The transceiver (410) sends the incoming information to the destination avatar in accordance with the selection of the destination avatar by the processor (408). Using the location context information and the user policy rule input to select a destination avatar may optionally include determining at least one destination avatar that best fits location context information. In addition, the routing avatar (402) may include an override unit (412) that is coupled to the transceiver and to the processor (408), wherein the override unit (412) is used for overriding the automatic selection of the destination avatar and providing for revising selection of the destination avatar.

In all embodiments, incoming and outgoing communications may be via wireless or hard-wired connections.

Thus, methods, a computer-readable medium and a destination selection system have been described according to the present invention. Many modifications and variations may be made to the techniques and structures described and illustrated herein without departing from the spirit and scope of the invention. Accordingly, it should be understood that the methods, computer-readable medium and destination selection system described herein are illustrative only and are not limiting upon the scope of the invention.

What is claimed is:

1. A method for automatically selecting, for a user, at least one destination avatar to which to send received information based on context information and user-defined policy-selection rules, comprising the steps of:
examining, by a destination selection system, user location information; and
determining the at least one destination avatar to which the received information is to be delivered based on the context information and the user-defined policy-selection rules.

2. The method of claim 1 further including a step of sending, by the at least one destination avatar, the received information to each device associated with the at least one destination avatar.

3. The method of claim 2 wherein the device is one of: a cellular phone, a personal computer located at a workplace, a laptop computer, personal computer located at a residence, and a camera.

4. The method of claim 1 wherein the user location information comprises at least one of: a user's behavior, a user's location, location of an individual proximate to the user, an object proximate to the user, the user's recent activities, and the user's planned activities.

5. The method of claim 1 wherein the destination selection system is a designated avatar.

6. The method of claim 1 including a step of overriding the automatic selection of the destination avatar.

7. A method for dynamically routing received electronic information for a user, comprising the steps of:
utilizing context information together with user-defined policy-selection rules to determine at least one destination avatar for the received information; and
sending the received electronic information to the at least one destination avatar.

8. The method of claim 7 further including a step of sending, by the at least one destination avatar, the received information to each device associated with the at least one destination avatar.

9. The method of claim 8 wherein the device associated with the at least one destination avatar is one of: a cellular phone, a personal computer located at a workplace, a laptop computer, personal computer located at a residence, and a camera.

10. The method of claim 7 wherein the context information comprises at least one of: the user's network address assignment, cellular data from the user's cellular phone, location data for the user, power information from the user's notebook computer, active application data from devices that the user is using, Web site work information and Web site recreational information.

11. The method of claim 7 wherein the location data is from Global Positioning System receivers.

12. The method of claim 7 wherein the user-defined policy-selection rules comprise rules that indicate a selected destination avatar for at least one of: urgent messages, work messages, personal messages, personal photographs, messages from a selected group of people to the user when the user is visiting a different office, and messages from people failing to be in the first group of people wherein the messages are sent to the user when the user is visiting a different office.

13. The method of claim 12 wherein the messages to the user when the user is in a different office include at least one of: cellular phone messages, email messages, and pager messages.

14. The method of claim 13 wherein the cellular phone messages, the email messages, and the pager messages have different rules for determining the at least one destination avatar.

15. The method of claim 7 including a step of overriding the automatic selection of the at least one destination avatar.

16. A computer-readable medium for implementing a destination selection system useful for directing received information in association with a plurality of devices for a user, wherein the plurality of devices are coupled to a computer network, the computer network providing a network connection for transmitting received information to a destination selection system for delivery to at least one device of the user, the computer-readable medium having computer-executable instructions for performing a method of automatically selecting, for the user, a destination avatar associated with at least one device of the plurality of devices based on context information and user-defined policy-selection rules, comprising the steps of:
examining, by the destination selection system, location information for the user; and
determining at least one destination avatar to which the received information is to be delivered based on the context information and the user-defined policy-selection rules.

17. The computer-readable medium of claim 16 wherein the destination selection system is a sorting avatar.

18. The computer-readable medium of claim 16 wherein the computer-executable instructions further include a step of sending, by the at least one destination avatar, the data to each device associated with the at least one destination avatar.

19. The computer-readable medium of claim 18 wherein the device associated with the at least one destination avatar is one of: a cellular phone, a personal computer located at a workplace, a laptop computer, personal computer located at a residence, and a camera.

20. The computer-readable medium of claim 16 wherein the context information comprises at least one of: the user's network address assignment, cellular data from the user's cellular phone, location data for the user, power information from the user's notebook computer, active application data from devices that the user is using, Web site work information and Web site recreational information.

21. The computer-readable medium of claim 20 wherein the location data is from Global Positioning System receivers.

22. The computer-readable medium of claim 16 wherein the user-defined policy-selection rules comprise rules that indicate a selected designation avatar for at least one of: urgent messages, work messages, personal messages, personal photographs, messages from a selected first group of people to the user when the user is visiting a different office, and messages from people failing to be in the first group of people wherein the messages are sent to the user when the user is visiting a different office.

23. The computer-readable medium of claim 16 wherein further computer-executable instructions are included for executing override instructions.

24. A destination selection system for automatically selecting a destination avatar for incoming communications for a user, comprising:
a routing avatar, comprising:
a context information unit, coupled to a processor and a transceiver, for storing location context information for the user;
a policy rule unit, coupled to the processor and to the transceiver, for storing user policy rule input;
the processor, coupled to the context information unit, the policy rule unit, and the transceiver, for using the location context information and the user policy rule input to select a destination avatar; and
a transceiver, coupled to receive incoming information, the context information unit, the policy rule unit and to the processor, for sending the incoming information to the destination avatar in accordance with the selection of the destination avatar by the processor.

25. The destination selection system of claim 24, wherein using the location context information and the user policy rule input to select a destination avatar comprises determining at least one destination avatar that best fits location context information.

26. The destination selection system of claim 24 wherein the routing avatar includes an override unit that is coupled to the transceiver and to the processor, for overriding the automatic selection of the destination avatar and providing for revised selection of the destination avatar.
